(19) United States
(12) Patent Application Publication
(10) Pub. No.: US 2010/0128874 A1
(43) Pub. Date: May 27, 2010

(54) ENCRYPTION / DECRYPTION IN PARALLELIZED DATA STORAGE USING MEDIA ASSOCIATED KEYS

(76) Inventor: Mark E. Scott-Nash, Boulder, CO (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/323,316

(22) Filed: Nov. 25, 2008

(51) Int. Cl. H04K 1/00

(52) U.S. Cl. 380/255

(57) ABSTRACT

A method and system to allow encryption/decryption to be performed substantially in parallel using one or more media associated keys. The system has an input buffer to store a plurality of media data from a plurality of media channels. A plurality of cryptographic engines is coupled with the input buffer to obtain a plurality of cipher keys and each cipher key is associated with one or more of a plurality of media channels The system encrypts or decrypts, substantially in parallel, each of the plurality of media data with a cryptographic algorithm using one or more of the obtained cipher keys.

### FIELD OF THE INVENTION

This invention relates to encryption/decryption, and more specifically but not exclusively, to parallelized encrypting or decrypting of data using one or more media associated keys.

### BACKGROUND DESCRIPTION

The advancement of technology in data storage media has allowed more data to be stored in smaller but yet more robust forms. The forms of data storage media include punch cards, tapes drives, floppy disks, zip disks, hard disk drives, solid state drives, and flash memory for example.

As more data storage capacity becomes available to users, more and more information, including sensitive and private information, are being stored on data storage media. One way of protecting the sensitive and private information stored in the data storage media is to use encryption. In typical encryption algorithms, a single cipher key is used to encrypt or decrypt the data within a particular keyscope on the data storage media.

One drawback of protecting the data storage media within a keyscope with a single cipher key is that if the cipher key is cracked or is known by an unauthorized user, all the information may be compromised. For example, in a hard disk drive with full-disk encryption feature, all the data that go through the data channels are encrypted and recorded on the hard disk platter. If the encryption key is cracked, all the information on the hard disk drive within a keyscope may be compromised.

### BRIEF DESCRIPTION OF THE DRAWINGS

The features and advantages of embodiments of the invention will become apparent from the following detailed description of the subject matter in which:

FIG. 1 illustrates a block diagram of a media storage device in accordance with one embodiment of the invention;

FIG. 2 illustrates a block diagram of a media controller in accordance with one embodiment of the invention;

FIG. 3 illustrates a block diagram of a cryptographic module in accordance with one embodiment of the invention;

FIG. 4 illustrates a block diagram of a cryptographic processor that is also a cryptographic module in accordance with one embodiment of the invention; and

FIG. 5 illustrates a block diagram of a system in accordance with one embodiment of the invention.

### DETAILED DESCRIPTION

Reference in the specification to “one embodiment” or “an embodiment” of the invention means that a particular feature, structure or characteristic described in connection with the embodiment is included in at least one embodiment of the invention. Thus, the appearances of the phrase “in one embodiment” appearing in various places throughout the specification are not necessarily all referring to the same embodiment.

Embodiments of the invention allow encryption/decryption to be performed substantially in parallel using one or more media associated keys. The media includes Not AND (NAND) flash memory, dynamic random access memory (DRAM), Not OR (NOR) flash memory, static RAM (SRAM), read only memory (ROM), electrically erasable programmable read only memory (EEPROM), and/or any other desired type volatile and non-volatile memory device.

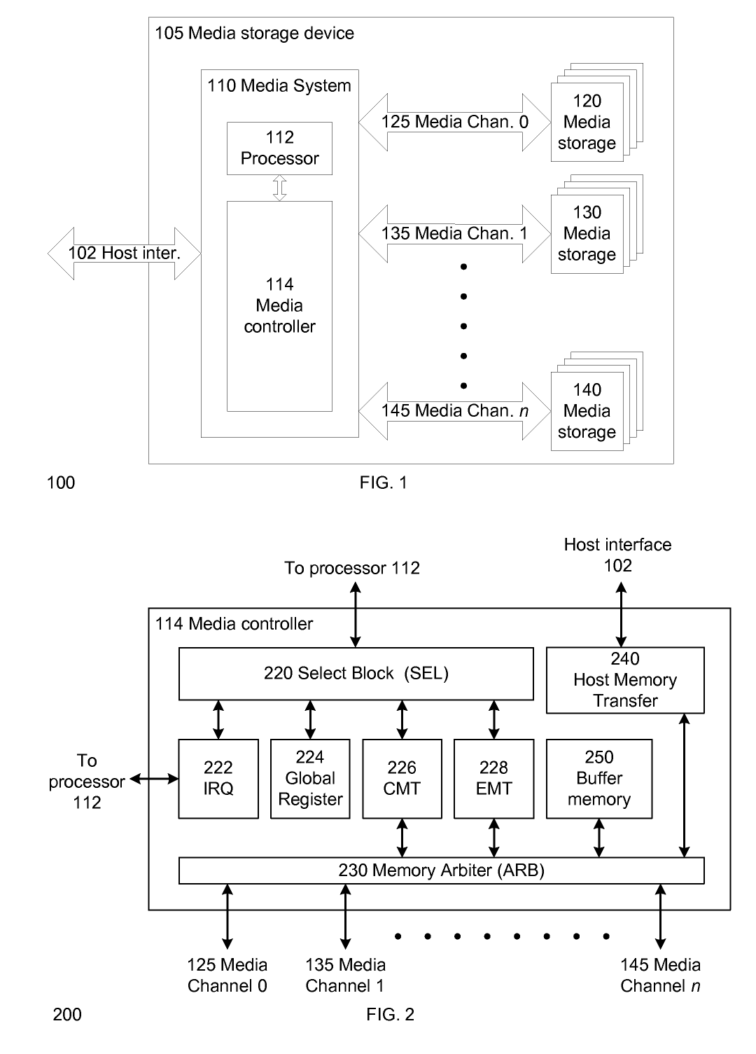

FIG. 1 illustrates a block diagram 100 of a media storage device 105. The media storage device 105 has a media system 110 and media storage units 120, 130 and 140. The media storage device 105 is capable of connecting to a host via the host interface 102. The host includes, but is not limited to, a desktop computer, a laptop computer, a notebook computer, a personal digital assistant (PDA), a server, a workstation, a cellular telephone, a mobile computing device, an Internet appliance or any other type of computing device. The host interface 102 includes, but is not limited to, serial advanced technology attachment (SATA) interface, small computer system interface (SCSI) interface, integrated drive electronics (IDE) interface, universal serial bus (USB) interface, and/or any other forms of wired or wireless communication interface. In one embodiment, the media storage device 105 is a solid state drive.

In an embodiment, the media system 110 has two modules, namely, the processor 112 and the media controller 114. The media system 110 is connected with media storage units 120 and 130 via media channel 0 125 and media channel 1 135 respectively. Media storage unit 140 shows that any arbitrary number n of media storage units can be connected in parallel with the media system 110 via media channel n 145. In addition, any number of the media storage units 120, 130, and 140 may each include multiple media storage units. For example, in one embodiment, the media system 110 has ten media channels and each media channel is connected with four media storage units.

During a write operation by the host, the media storage device 105 receives data to be stored via the host interface 102. In one embodiment, the media controller 114 receives the data to be stored directly via the host interface. In another embodiment, the data is buffered in a buffer memory before it is sent to the media controller 114. The data may be processed before it is sent to the media controller 114 in another embodiment. The processing of the data includes, but is not limited to, serialization, deserialization, parsing of the data, or any form of processing that makes the data in a form suitable for processing by the media controller 114 or by the host.

When the media controller 114 receives the data, it partitions the data into substantially equal parts among the media channels 125, 135 and 145. As the data to be stored may not be exactly divisible by the number of media channels, some media channels may have a smaller or bigger partition of data than the other media channels. If the transfer speeds of the media channels 125, 135 and 145 are similar, the time to transfer the partitioned would be similar if each media channel is transferring partitioned data of substantially equal sizes. In one embodiment, if the transfer speeds of the media channels 125, 135 and 145 are not the same, the data is partitioned for each channel in such a way that the time taken to transfer the partitioned data for each channel is substantially equal.

In other embodiments, the media controller 114 does not partition the data among all the media channels, i.e., the media controller 114 partitions the data among some of media channels. One or more media channels may be unusable due to a communication fault or due to the inability to store more data as the media storage units connected to the one or more media channels are full. As such, the media controller 114 does not consider these unusable channels when partitioning the data.

The methods described herein of partitioning the data into substantially equal parts among the media channels are not meant to be limiting, and one of ordinary skill in the relevant art will readily appreciate that other ways of partitioning the data in substantially equal parts are possible and the other ways can be also be applied to the invention. The partitioning of the data should not be done in a way that unduly reduces the efficiency of parallelized data storage. By way of example, if the data is partitioned among the media channels such that one media channel constantly requires more than two times the time to transfer the partitioned data compared to the other channels, then the partitioning of the data unduly reduces the efficiency of the parallelized data storage.

After the media controller 114 partitions the data to be stored into substantially equal parts among the media channels 125, 135 and 145, the media controller 114 encrypts the partitioned data substantially in parallel. The encryption of the partitioned data is performed by the media controller 114 with a cryptographic algorithm using one or more cipher keys. The cryptographic algorithm includes, but is not limited to, AES using cipher block chaining (CBC), the Data Encryption Standard (DES), Triple Data Encryption Standard (3DES), International Data Encryption Algorithm (IDEA), Blowfish, RSA, RC4, or any other data-encryption algorithm.

In one embodiment, the media controller 114 obtains the media channel identification of the media channels 125, 135 and 145. In another embodiment, the media controller 114 obtains the media storage identification of the media storage units 120, 130 and 140 coupled to the media channels 125, 135 and 145. The cipher key is generated by executing a key generation algorithm using the processor 112. The key generation algorithm includes, but is not limited to, a cryptographic hash algorithm such as a message digest algorithm 5 (MD5) or any of the secure hash algorithms (SHA) published by the National Institute of Standards and Technology (NIST) as a United States (U.S.) U.S. Federal Information Processing Standard (FIPS).

In one embodiment, the cipher key(s) associated with each media channel 125, 135 and 145 is generated based on a master key and the media channel identification of the media channels 125, 135 and 145. For example, to generate the cipher key for media channel 125, the key generation algorithm is first executed on the processor 112 with the master key as the input. The result of the first execution of the key generation algorithm is concatenated with the media channel identification of the media channel 125. The key generation algorithm is executed again on the processor 112 with the concatenated result as an input to generate the cipher key for media channel 125. In another example, the cipher key for media channel 125 is generated by firstly, concatenating the master key with the media channel identification of the media channels 125 and secondly, executing the key generation algorithm using the processor 112 with the concatenated result as the input.

The methods disclosed herein to generate the cipher key(s) associated with each media channel 125, 135 and 145 based on the master key and the media channel identification of the media channels 125, 135 and 145 are not meant to be limiting. One of ordinary skill in the relevant art will readily appreciate that there are other ways or combination of steps to generate the cipher key(s) associated with each media channel 125, 135 and 145 based on the master key and the media channel identification of the media channels 125, 135 and 145 and the alternative ways can be also be applied to the invention.

In one embodiment, the media controller 114 generates a unique cipher key for each of the media channels 125, 135 and 145. After the encryption is completed, the encrypted partitioned data for each media channel 125, 135 and 145 are stored substantially in parallel in the media storage units 120, 130 and 140 respectively. By having a unique cipher key for each of the media channels 125, 135 and 145, the data security of the media storage device 105 is increased. For example, if media storage unit 120 is removed from the media storage device 105, the successful analysis of the cipher key for media storage unit 120 does not compromise the data stored in other media storage units 130 and 140. This is because the cipher key for media storage unit 120 is different from the cipher keys for media storage units 130 and 140. Security is enhanced by removing the logical association of the data in media storage unit 120 with the data in other media storage units 130 and 140 while maintaining the key scope for each media storage unit. This also allows replacement of any number of media storage units without affecting the cryptographic data integrity of any of the other units.

The media controller 114 may also use the media storage identification of the media storage units 120, 130 and 140 to generate the cipher key(s) for the media channels 125, 135 and 145. The media storage identification includes, but is not limited to, a fuse identification, a default register identification, a serial number, or any form of identification that is capable of differentiating between the media storage units. In one embodiment, if there is more than one media storage unit connected with each media channel 125, 135 and 145, the media controller 114 selects one of the media storage units connected with each media channel and the media storage identification of the selected media storage unit is used to generate the cipher key(s) for the media channel. In other embodiments, the media controller 114 may use any combination of the media storage identification of the media storage units connected with each media channel to generate the cipher key for each media channel.

One cipher key may also be shared between two or more media channels. For example, the media controller 114 may utilize the cipher key for media channel 125 for the data encryption of media channels 125 and 135. In another embodiment, the media controller 114 may utilize the cipher keys for media channel 125 and 135 for the data encryption of media channel 145. One of ordinary skill in the relevant art will readily appreciate that any combination of the ciphers keys for each of the media channels 125, 135 and 145 may be used by the media controller 114 for the encryption of partitioned data for each media channel 125, 135 and 145.

During a read operation by the host, the media controller 114 retrieves all the encrypted partitioned data from the media storage units 120, 130 and 140 via the media channels 125, 135 and 145 respectively. After all the encrypted partitioned data are retrieved, the media controller 114 performs decryption of the retrieved data substantially in parallel. The decryption is performed with the same cryptographic algorithm using the same cipher key that is used to encrypt the partitioned data. The media controller 114 combines the decrypted data into host data and sends the host data via the host interface 102. In one embodiment, the media storage device 105 is operable to perform read and write operations in parallel. The media controller 114 encrypts and decrypts data substantially in parallel.

During the manufacturing phase of the media storage device 105, individual media storage units 120, 130 and 140 can be removed or replaced without affecting the keys or the data on other media storage units. When a cipher block chaining cryptographic algorithm is used, for example, the failure of one media storage unit does not cause data loss on the other blocks cipher-chained across the other media storage units as they do not share the same cipher key. The parallel design of the media channels 125, 135 and 145 allows versatility as the encryption/decryption can be enabled or disabled on a per media storage unit Or per media channel basis.

FIG. 2 illustrates a block diagram 200 of the media controller 114. The select block (SEL) 220 interfaces the processor 112 with four modules, namely, the interrupt control (IRQ) module 222, the global register module 224, the central processing unit (CPU) memory transfer (CMT) module 226 and the encryptor memory transfer (EMT) module 228. The SEL 220 facilitates access of the media storage controller 114 by the processor 112.

The IRQ module 222 generates interrupts that are sent to the processor when required. The global register module 224 contains general registers and configuration registers. The CMT module 226 manages the read and the write operations of the media controller 114. The host memory transfer module 240 processes the data that is received from or sent to the host during a write and read operation by the host respectively. The processing of the data includes, but is not limited to, serialization, deserialization, parsing the data, data format conversion, buffering, or any form of processing that makes the data in a form suitable for processing by the media controller 114 or by the host.

During a write operation by the host, the host memory transfer module 240 receives the data and processes it. In some embodiments, no processing is required and the host memory transfer module 240 places the data in the buffer memory 250 via the memory arbiter (ARB) 230. The ARB 230 is a bus that mediates the data transfer among the CMT module 226, EMT module 228, buffer memory 250, host memory transfer module 240 and the media channels 125, 135 and 145 as the bus speed of the various modules may not be the same.

The CMT module 226 partitions the data in the buffer memory 250 into substantially equal parts among the media channels 125, 135 and 145. In one embodiment, the CMT module 226 performs the data partitioning by creating buffer pointers to the buffer memory module 250 to point to data contents that are substantially equal in size. For example, if there is a contiguous block of data of 1024 bytes stored in the buffer memory at start address 0×10h, three different buffer pointers is created by the CMT module 226 for a media storage device that supports three media channels. The first buffer pointer starts at memory address 0×00h and ends at memory address 0×154h (size of 341 bytes). The second buffer pointer starts at memory address 0>155 h and ends at memory address 0×2A9h (size of 341 bytes). The third pointer starts at memory address 0×2AAh and ends at memory address 0×3FFh (size of 342 bytes).

In one embodiment, the CMT module 226 provides the buffer pointers to the EMT module 228 and the EMT module 228 encrypts substantially in parallel, the partitioned data for the media channels 125, 135 and 145 with the cryptographic algorithm using one or more of the obtained cipher keys as described earlier. After the partitioned data is encrypted by the EMT module 228, the EMT module 228 sends the encrypted partitioned data via the ARB 230 to the buffer memory 250 for storage. The CMT module 226 transfers the encrypted partitioned data from the buffer memory 250 via the ARB 230 to the media channels 125, 135 and 145 for storing the encrypted partitioned data in the media storage units 120, 130 and 140 respectively. In another embodiment, the EMT module 228 bypasses the buffer memory 250 and sends the encrypted partitioned data via the ARB 230 to the media channels 125, 135 and 145 for storing the encrypted partitioned data in the media storage units 120, 130 and 140 respectively.

During a read operation by the host, the CMT module 226 retrieves all the encrypted partitioned data from the media storage units 120, 130 and 140 via the media channels 125, 135 and 145 respectively. In one embodiment, the CMT module 226 transfers the retrieved encrypted partitioned data to the buffer memory 250. The EMT module 228 retrieves the encrypted partitioned data from the buffer memory 250 via the ARB 230. In another embodiment, the CMT module 226 bypasses the buffer memory 250 and transfers the retrieved encrypted partitioned data to the EMT module 228 via the ARB 230.

The EMT module 228 performs decryption of the retrieved data substantially in parallel. The decryption is performed with the same cryptographic algorithm using the same cipher key(s) that is used to encrypt the partitioned. After the decryption is completed, the EMT 228 transfers the decrypted data to the buffer memory 250. The CMT module 226 combines the decrypted data into host data. In one embodiment, the CMT module 226 arranges the decrypted data contiguously and sends the buffer pointer to the decrypted data to the host transfer memory module 240. The host memory transfer module 240 receives the buffer pointer and sends the host data in the buffer memory 250 to the host via the host interface 102.

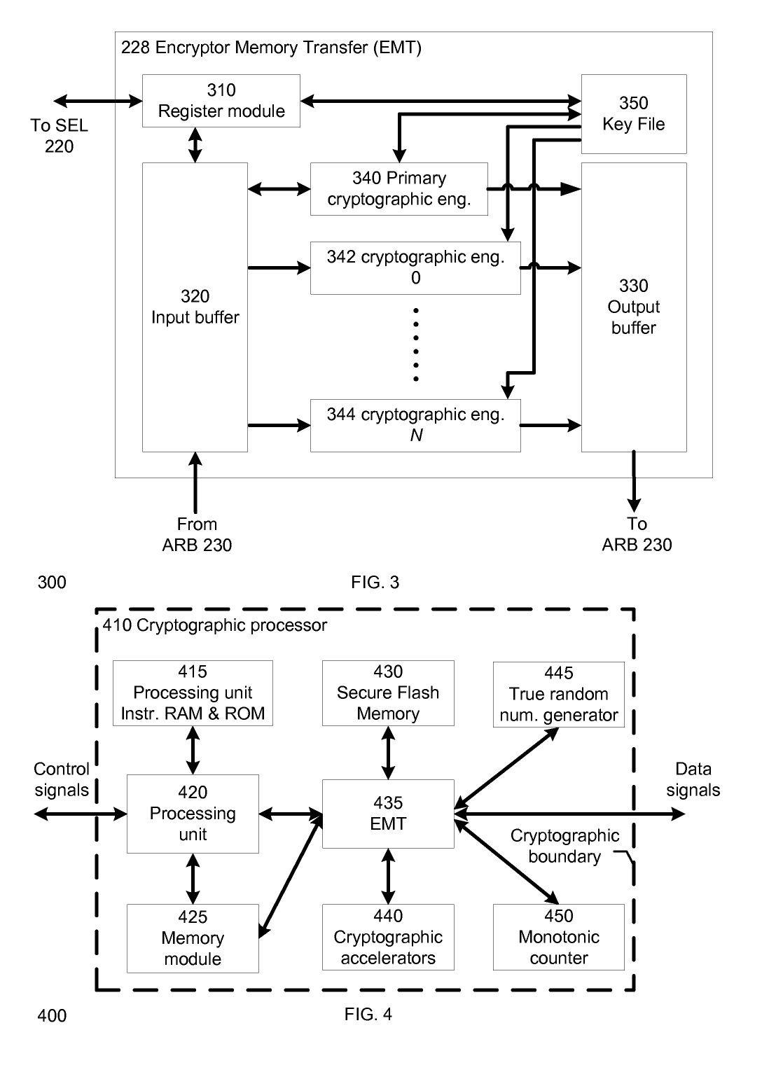

FIG. 3 illustrates a block diagram 300 of a cryptographic module 228. In one embodiment, the cryptographic module 228 is the EMT module 228. The cryptographic module 228 has an input buffer 320 to store data via the ARB 230. The data may be from the buffer memory 250 or may be from the media storage units 120, 130 and 140. The input buffer 320 is connected with a primary cryptographic engine 340 and cryptographic engine 0 342. Cryptographic engine N 344 shows that any arbitrary number N of cryptographic engines can be connected to the input buffer 320. The cryptographic engines 340, 342 and 344 perform encryption and decryption of the data stored in the input buffer 320.

The cryptographic engines 340, 342 and 344 are connected with an output buffer to store the encrypted or decrypted data after the encryption or decryption of data performed is by the cryptographic engines 340, 342 and 344. The input buffer 320 and output buffer 330 can be of any size and may have equal or unequal sizes. In one embodiment, the number of cryptographic engines is equal to the number to media channels 125, 135 and 145. In other embodiments, the number of cryptographic engines is more or less than the number to media channels 125, 135 and 145. The number of cryptographic engines may be dependent on the amount of logic required to implement the cryptographic algorithm and the chip area.

The cryptographic module 228 is initialized prior to any encryption or decryption operations. The primary cryptographic engine 340 obtains the media identification of the media channels 125, 135 and 145. In another embodiment, the primary cryptographic engine 340 reads and obtains the media storage identification of media storage units 120, 130 and 140. The media identification of the media channels 125, 135 and 145 and/or the media storage identification of media storage units 120, 130 and 140 are stored in a key file module 350 that is connected to the cryptographic engines 340, 342 and 344.

The register module 310 is connected with the key file module 350 and with the input buffer 320 to facilitate access of the cryptographic module 228 by the processor 112. In one embodiment, the processor 112 provides the master key to the register module 310. The register module 310 provides the master key to the primary cryptographic engine 340 via the input buffer 320 or via the key file module 360. The primary cryptographic engine 340 generates the unique cipher keys for the media channels 125, 135 and 145 with the key generation algorithm as-described earlier using the master key, and/or the media identification of the media channels 125, 135 and 145 and/or the media storage identification of media storage units 120, 130 and 140. The generated cipher key(s) for each channel 125, 135 and 145 are stored in the key file module 350.

By having multiple cryptographic engines running substantially in parallel, the performance of the cryptographic module 228 is improved. The time required to encrypt or to decrypt the data is reduced with higher parallelism. In addition, if the cipher keys are associated with the media storage units, a security structure like the redundant array of independent disks (RAID) structure can be achieved at the media storage unit level. The cryptographic module 228 is easily scaleable as the number of cryptographic engines can be added or removed without affecting the operation of the cryptographic module 228. In addition, the cryptographic engines 340, 342 and 344 are not limited to be of the same type of engine. For example, cryptographic engine 340 can be using AES cryptographic algorithm, and cryptographic engine 342 can be using Blowfish cryptographic algorithm. One of ordinary skill in the relevant art will readily appreciate that any combination of the different types of the cryptographic engines 340, 342 and 344 can be operated in parallel and can encrypt / decrypt different media channels or media storage units with different cryptographic algorithms.

After the cryptographic module 228 is initialized, encryption and decryption operations can be performed. In one embodiment, during a write operation by the host, the cryptographic module 228 receives the buffer pointers of the partitioned data from the CMT module 226. The cryptographic module 228 transfers the partitioned data based on the buffer pointers via the ARB 230 into the input buffer. The cipher key(s) associated with each media channel 125, 135 and 145 is obtained by the cryptographic engines 340, 342 and 344 from the key file module 350 and the partitioned data is encrypted substantially in parallel with the cryptographic algorithm discussed earlier using one or more of the obtained cipher keys. After the partitioned data is encrypted, it is written to the output buffer 330. In one embodiment, the encrypted data is transferred via the ARB 230 to the media channels 125, 135 and 145 for storage in the media storage units 120, 130 and 140. In another embodiment, the encrypted data is first transferred via the ARB 230 to the buffer memory 250. The CMT module 226 then transfers the encrypted data in the buffer memory 250 via the ARB 230 to the media channels 125, 135 and 145 for storage in the media storage units 120, 130 and 140.

During a read operation by the host, the cryptographic module 228 retrieves all the encrypted partitioned data from the buffer memory 250 via the ARB 230 and stores the encrypted partitioned data in the input buffer 320. In another embodiment, the cryptographic module 228 bypasses the buffer memory 250 and retrieves the encrypted partitioned data from the media storage units 120, 130 and 140 via media channels 125, 135 and 145 and via the ARB 230 and stores the encrypted partitioned data in the input buffer 320. The cipher key(s) associated with the media channels are obtained by the cryptographic engines 340, 342 and 344 from the key file module 350 and the encrypted partitioned data is decrypted substantially in parallel with the same cryptographic algorithm used during the encryption of the partitioned data using the same cipher key(s).

After the encrypted partitioned data is decrypted, it is written to the output buffer 330. The cryptographic module 228 transfers the decrypted data to the buffer memory 250. The CMT module 226 combines the decrypted data into host data. In one embodiment, the CMT module 226 arranges the decrypted data contiguously and sends the buffer pointer to the decrypted data to the host transfer memory module 240. The host memory transfer module 240 receives the buffer pointer and sends the host data in the buffer memory 250 to the host via the host interface 102.

FIG. 4 illustrates a block diagram 400 of a cryptographic processor 410 that is also a cryptographic module in accordance with one embodiment of the invention. The cryptographic processor 410 has a well defined cryptographic boundary that is compliant with the FIPS publication 140-2, “Security requirements for cryptographic modules security requirements for cryptographic modules”, NIST, published on May 25, 2001. The cryptographic processor 410 has 7 modules, namely, the processing unit 420, the processing unit instruction read access memory (RAM) and read only memory (ROM) 415, the memory module 425, the EMT module 435, the secure flash module 430, the cryptographic accelerators module 440, the monotonic counter 450, and the true random number generator module 445.

The processing unit 420 is accessible by bidirectional control signals outside the cryptographic boundary and bidirectional data signals are received via the EMT module 435. The cipher keys of the EMT module 435 are stored in the tamper resistant secure flash memory module 430. The true random number generation module 445 provides a true random number based on physical entropy to the EMT module 435. The true random number can be used as an input for key generation algorithms or for any other cryptographic or data security related function requiring random numbers. The processing unit 415 executes instructions in the processing unit instruction RAM and ROM 415. The EMT module 435 is connected to a cryptographic accelerators module 440 containing but not limited to, public key cryptographic accelerators, cryptographic hash accelerators, and block and stream cipher accelerators. The EMT module 435 is also connected to the memory module 425 for buffering of data and to the monotonic counter 450 that can be used to prevent replay attacks.

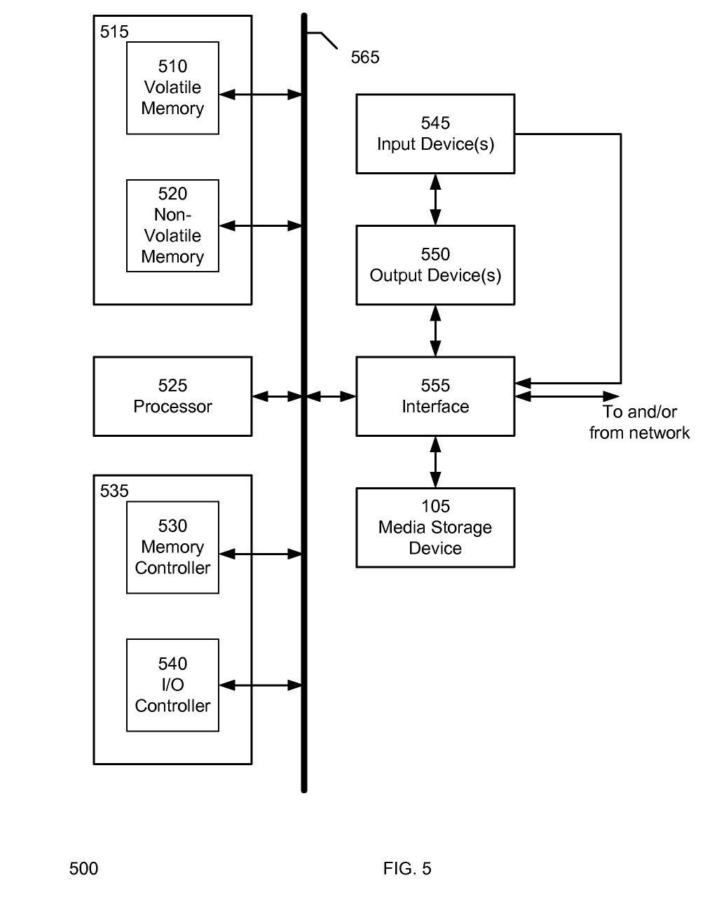

FIG. 5 illustrates a block diagram of a system 500 to implement the methods disclosed herein according to an embodiment. The system 500 includes but is not limited to, a desktop computer, a laptop computer, a notebook computer, a personal digital assistant (PDA), a server, a workstation, a cellular telephone, a mobile computing device, an Internet appliance or any other type of computing device. In another embodiment, the system 500 used to implement the methods disclosed herein may be a system on a chip (SOC) system.

The system 500 includes a chipset 535 with a memory controller 530 and an input/output (I/O) controller 540. A chipset typically provides memory and I/O management functions, as well as a plurality of general purpose and/or special purpose registers, timers, etc. that are accessible or used by the processor 525. The processor 525 may be implemented using one or more processors.

The memory controller 530 performs functions that enable the processor 525 to access and communicate with a main memory 515 that includes a volatile memory 510 and a non-volatile memory 520 via a bus 565. The volatile memory 510 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 520 includes, but is not limited by, flash memory, ROM, EEPROM, and/or any other desired type of memory device.

Memory 515 stores information and instructions to be executed by the processor 525. Memory 515 may also stores temporary variables or other intermediate information while the processor 525 is executing instructions. The system 500 includes, but is not limited to, an interface circuit 555 that is coupled with bus 565. The interface circuit 555 is implemented using any type of well known interface standard including, but is not limited to, an Ethernet interface, a universal serial bus (USB), a third generation input/output interface (3GIO) interface, and/or any other suitable type of interface.

One or more input devices 555 are connected to the interface circuit 555. The input device(s) 545 permit a user to enter data and commands into the processor 525. For example, the input device(s) 545 is implemented using, but is not limited to, a keyboard, a mouse, a touch-sensitive display, a track pad, a track ball, and/or a voice recognition system.

One or more output devices 550 connect to the interface circuit 555. For example, the output device(s) 550 are implemented using, but are not limited to, light emitting displays (LEDs), liquid crystal displays (LCDs), cathode ray tube (CRT) displays, printers and/or speakers). The interface circuit 555 includes a graphics driver card. The system 500 also includes one or more media storage devices 105 to store software and data.

The interface circuit 555 includes a communication device such as a modem or a network interface card to facilitate exchange of data with external computers via a network. The communication link between the system 500 and the network may be any type of network connection such as an Ethernet connection, a digital subscriber line (DSL), a telephone line, a cellular telephone system, a coaxial cable, etc.

Access to the input device(s) 545, the output device(s) 550, the media storage device(s) 105 and/or the network is typically controlled by the I/O controller 540 in a conventional manner. In particular, the I/O controller 540 performs functions that enable the processor 525 to communicate with the input device(s) 545, the output device(s) 550, the media storage device(s) 105 and/or the network via the bus 565 and the interface circuit 555.

While the components shown in FIG. 5 are depicted as separate blocks within the system 500, the functions performed by some of these blocks may be integrated within a single semiconductor circuit or may be implemented using two or more separate integrated circuits. For example, although the memory controller 530 and the I/O controller 540 are depicted as separate blocks within the chipset 535, one of ordinary skill in the relevant art will readily appreciate that the memory controller 530 and the I/O controller 540 may be integrated within a single semiconductor circuit.

Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “substantially in parallel” used herein refers to an event where two or more operations are performed simultaneously. The two or more operations do not have to start at the same time or end at the same time as long as there is an overlap period of time where the two or more operations are happening simultaneously. The term “is operable” used herein means that the device, system, protocol etc., is able to operate or is adapted to operate for its desired functionality when the device or system is in off-powered state.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A cryptographic module comprising:
a plurality of cryptographic engines coupled with a plurality of media channels, each of the plurality of cryptographic engines to:
receive data from one or more of the plurality of media channels;
obtain a plurality of cipher keys, each cipher key associated with one or more of the plurality of media channels; and
perform in a substantially parallel manner one of encryption and decryption, on the data using one or more of the obtained cipher keys.

2. The cryptographic module of claim 1 further comprising an output buffer coupled with the cryptographic engines to store the encrypted or decrypted media data responsive to the encryption or decryption.

3. The cryptographic module of claim 1, wherein the plurality of cryptographic engines comprises a primary cryptographic engine to:
obtain a media identification of each of the plurality of media channels; and
generate the cipher keys based at least on the media identification and a master key.

4. The cryptographic module of claim 3, further comprising a key file module coupled with the cryptographic engines to store the generated cipher keys, and wherein the cryptographic engines to obtain the cipher keys is to obtain the generated cipher keys from the key file module.

5. The cryptographic module of claim 3, wherein each of the plurality of cryptographic engines to perform in a substantially parallel manner one of encryption and decryption is to:
encrypt or decrypt the data with a cryptographic algorithm using one or more of the generated cipher keys.

6. The cryptographic module of claim 5, where the cryptographic algorithm of the cryptographic engines is operable in accordance with an advanced encryption standard (AES) using cipher block chaining (CBC), with a block cipher based encryption standard, or with a block mode based encryption standard.

7. The cryptographic module of claim 3, further comprising a register module coupled with the key file module and with the input buffer to facilitate access of the cryptographic module by a processor, wherein the processor provides the master key to the register module.

8. A media storage controller comprising:
a memory arbiter module to facilitate access of data from a plurality of media channels; and
a cryptographic module coupled with the memory arbiter module comprising:
a plurality of cryptographic engines, each of the plurality of cryptographic engines to:
receive the data from one or more of the plurality of media channels;
obtain a plurality of cipher keys, each cipher key associated with one or more of the plurality of media channels; and
perform in a substantially parallel manner one of encryption and decryption, on the data using one or more of the obtained cipher keys.

9. The media storage controller of claim 8, wherein the cryptographic module further comprises an output buffer coupled with the cryptographic engines to store the encrypted or decrypted data responsive to the encryption or decryption.

10. The media storage controller of claim 8, wherein the plurality of cryptographic engines in the cryptographic module comprises a primary cryptographic engine to:
obtain a media identification of each of the plurality of media channels; and
generate the cipher keys based at least on the media identification and a master key.

11. The media storage controller of claim 10, wherein the cryptographic module further comprises a key file module coupled with the cryptographic engines to store the generated cipher keys, and wherein the cryptographic engines to obtain the cipher keys is to obtain the generated cipher keys from the key file module.

12. The media storage controller of claim 10, wherein each of the plurality of cryptographic engines in the cryptographic module to perform in a substantially parallel manner one of encryption and decryption is to:
encrypt or decrypt the data with a cryptographic algorithm using one or more of the generated cipher keys.

13. The media storage controller of claim 12, where the cryptographic algorithm of the cryptographic engines in the cryptographic module is operable in accordance with advanced encryption standard (AES) using cipher block chaining (CBC), with a block cipher based encryption standard, or with a block mode based encryption standard.

14. The media storage controller of claim 11 further comprising a select block coupled with the cryptographic module, and wherein the cryptographic module further comprises a register module coupled with the key file module and with the input buffer to facilitate access of the media storage controller by a processor, wherein the processor is to provide the master key to the register module.

15. A media storage device comprising:
a media system having a host interface and a plurality of media channels comprising;
a processor;
a controller coupled with the processor to:
receive data from the host interface;
partition the data into substantially equal parts among the plurality of media channels; and
encrypt the partitioned data substantially in parallel; and
a plurality of media storage units coupled to each of the plurality of media channels to store the encrypted partitioned data substantially in parallel.

16. The media storage device of claim 15, wherein the controller in the media system is further to:
retrieve all the encrypted partitioned data;
decrypt the retrieved data substantially in parallel;
combine the decrypted data into host data; and
send the host data via the host interface.

17. The media storage device of claim 15, wherein the host interface of the media system is operable in accordance with serial advanced technology attachment (SATA) interface, small computer system interface (SCSI) interface, universal serial bus (USB) interface or integrated drive electronics (IDE) interface.

18. The media storage device of claim 16, wherein the controller of the media system is further to:
obtain a media channel identification of each of the plurality of media channels;
obtain a media storage identification of at least one of the plurality of media storage units; and
generate a plurality of cipher keys, each cipher key associated with one or more of the plurality of media channels, based at least on a master key, and either on the media channel identification or on the media storage identification.

19. The media storage device of claim 18, wherein the controller of the media system to encrypt or to decrypt the partition data is to:
encrypt or decrypt the partitioned data with a cryptographic algorithm using one or more of the generated cipher keys.

20. The media storage device of claim 18, wherein the controller of the media system to encrypt or to decrypt the partition data is to:
encrypt or decrypt a first one of the partitioned data with a cryptographic algorithm using one or more of the generated cipher keys; and
encrypt or decrypt a second one of the partitioned data with another cryptographic algorithm using one or more of the generated cipher keys.

21. The media storage device of claim 18, wherein the media storage device is a solid state drive.

22. The media storage device of claim 19, wherein the cryptographic algorithm of the controller is operable in accordance with advanced encryption standard (AES) using cipher block chaining (CBC), with a block cipher based encryption standard, or with a block mode based encryption standard.

23. The media storage device of claim 20, wherein the first and the second cryptographic algorithms of the controller is operable in accordance with advanced encryption standard (AES) using cipher block chaining (CBC), with a block cipher based encryption standard, or with a block mode based encryption standard.
